(19) United States
(12) Patent Application Publication
(10) Pub. No.: US 2022/0153980 A1
(43) Pub. Date: May 19, 2022

(54) ORGANIC RESIN CARRYING TERTIARY AMINE AND CARBOXYLIC ACID GROUPS, AND AQUEOUS DISPERSION COMPRISING SAME, FOR A TWO-COMPONENT CROSSLINKABLE COMPOSITION

(71) Applicant: Arkema France, Colombes (FR)

(72) Inventors: Camara Fatoumata, Verneuil En Halatte (FR); Frank Cogordan, Verneuil En Halatte (FR); Virginie Decomble, Verneuil En Halatte (FR); Franck Moriere, Verneuil En Halatte (FR)

(21) Appl. No.: 17/442,312

(22) PCT Filed: Mar. 27, 2020
(86) PCT No.: PCT/FR2020/000070

§ 371 Date: Sep. 23, 2021

(30) Foreign Application Priority Data
Mar. 28, 2019 (FR) 1903294

(51) Int. Cl. C08L 25/14; C09D 125/14; C09D 11/107; C09J 125/14

(52) U.S. Cl. CPC C08L 25/14; C09D 125/14; C09D 11/107; C08L 2312/00; C08L 2205/035; C08L 2201/50; C09J 125/14

(57) ABSTRACT

The present invention relates to a specific organic resin, in particular an acrylic, vinyl or acrylic-vinyl resin, bearing tertiary amine and carboxylic acid groups, which resin is capable of forming an aqueous dispersion without surfactant, to a process for preparing this aqueous dispersion, and to crosslinkable coating compositions comprising said resin or said aqueous dispersion, for the preparation of crosslinked coatings without any use of isocyanate.

### TECHNICAL FIELD

The present invention relates to a specific organic resin, in particular an acrylic, vinyl or acrylic-vinyl resin, bearing tertiary amine and carboxylic acid groups, which resin is capable of forming an aqueous dispersion without surfactant, to a process for preparing this aqueous dispersion, and to two-component crosslinkable compositions comprising said resin or said aqueous dispersion, for the preparation of crosslinked products, without any use of isocyanates.

More particularly, the present invention relates to obtaining crosslinked coatings having a performance equivalent to that of crosslinked polyurethane coatings starting from a reactive system containing two components, one being the resin containing tertiary amine and carboxylic acid groups of the invention as a dispersion in an aqueous medium, and the other being an epoxy resin, this being without the need for isocyanates which are generally associated with polyols in order to obtain polyurethane coatings by the standard route.

### PRIOR ART

Obtaining crosslinked polyurethane coatings from a two-component system in an organic solvent medium or in an aqueous medium in dispersion, starting from a polyol resin by reaction with a polyisocyanate, is already well known. More particularly, acrylic polyols are known for coating applications in view of their better performance, in particular as regards aging. These polyols are copolymers of a mixture of acrylic monomers comprising a hydroxyalkyl (meth)acrylate, such as hydroxyethyl (meth)acrylate (HE(M)A), hydroxypropyl (meth)acrylate and hydroxybutyl (meth)acrylate.

The essential drawback of these systems is linked to the use of isocyanates (polyisocyanates), which are essential crosslinking agents for these crosslinked two-component polyurethane systems based on acrylic polyol resins. Specifically, this use gives rise to problems of toxicity, safety and harmfulness to human health and to the environment in general, which problems impose severe restrictions as regards their handling, even in an aqueous medium, which thus becomes ever more complex and expensive. Given their toxicity and their preparation from raw materials that are also toxic and harmful to the environment, such as phosgene with the emission of hydrochloric acid, which is also harmful to the environment, this chemistry, based on the use of isocyanates, needs to be replaced with solutions that are less harmful to humans and the environment.

Furthermore, in addition to human health and environmental problems, the use of a crosslinkable polyol-isocyanate system is highly sensitive to the application conditions, whether in a solvent medium or aqueous medium (even higher isocyanate consumption), with consumption of some of the isocyanate functions by the residual water in a solvent medium or by the water in an aqueous medium with a stoichiometry which is difficult to control having an effect on the reproducibility of the final performance and resulting in an overconsumption of isocyanates compared with the stoichiometry required. The consumption of isocyanates in the system by ambient moisture or by water in an aqueous medium with secondary reactions (decarboxylation and formation of polyamines converted into polyureas) may affect the structure and final performance of the coating. In particular, the release of CO₂ by reaction with water leads to the formation of CO₂ bubbles (defects) in the final coating, in particular in the case of thick coatings. This is a significant limitation of the conventional polyol-isocyanate system in terms of the maximum dry thickness possible without said defect (CO₂ bubbles) for a conventional polyurethane coating. This maximum dry thickness performance without said defect is known as the “pinhole limit” measured by the pinhole limit test as defined in the examples (according to the ISO 4628-2 standard). In conventional polyurethane coating systems (based on isocyanates), this maximum thickness is at best 70 μm. In the crosslinked products of the invention, these defects are not present, and thus there is no limitation. The other drawback of isocyanates in these coatings is their high impact on the cost price, in particular accentuated by the overconsumption of isocyanates by the secondary reaction with water. Novel two-component systems are already known from the prior art that do not use polyisocyanate (known as NIPU: non-isocyanate PU) for replacing polyurethane systems based on polyol-polyisocyanate.

In particular, US 2012/0251730 describes a two-component solvent-based composition that is capable of drying without using polyisocyanates or without melamine-formaldehyde resins as crosslinking agents. It consists of a copolymer obtained by radical polymerization and containing at least one cyclic carbonate group, a polyamine having at least two primary and secondary amine groups, optionally at least one solvent, pigment and additive. The examples show a film having an advantageous hardness, but do not make it possible to obtain compositions having a low content of volatile organic compounds (VOCs).

US 2002/0176994 also describes a reactive, isocyanate-free, coating composition obtained from an anhydride functionalized acrylic polymer, by mixing with other epoxy, tertiary amine and hydroxyl functionalized polymers, without these polymers being copolymerized with one another. The simple mixing of a hydrophobic polymer with a hydrophilic polymer however leads to compatibility problems between the two polymers, difficulties during emulsification and instability of the emulsions obtained.

Although the systems as described in the cited prior art documents make it possible a priori to obtain crosslinkable coatings without using a polyisocyanate, several additional problems remain to be overcome.

As the regulations regarding reducing VOCs become stricter, solutions to this problem are not known in the prior art. There is therefore a need for novel resins, in particular acrylic resins, functionalized with tertiary amines that are capable of forming stable aqueous dispersions and enabling the formulation of aqueous coatings and in particular paints, varnishes, inks, adhesives and glues with a low VOC content, and with an aqueous dispersion thus obtained that is suitable for application in coatings in an aqueous medium. The technical problem to be solved by the present invention therefore consists firstly in finding a resin specifically selected not to need to use isocyanates, bearing tertiary amine and carboxylic acid groups having a high solids content in an organic solvent medium, that is capable of forming a storage-stable aqueous dispersion, that can be used in a specific two-component system, crosslinkable at relatively low temperature ranging from ambient temperature (20-25° C.) to 150° C., with an epoxy resin as crosslinking agent, and that has a low VOC content and a solids content ranging from 30% to 60%. This specific system as targeted must be a novel two-component system which can be crosslinked without using any isocyanate and, for this reason and because of the need to reduce the VOC content, it has to be environmentally friendly and health friendly, and in particular it must not be sensitive to water and must have similar if not identical performance to that of a comparable polyol-polyisocyanate system of the prior art.

More particularly, the present invention makes it possible, by a particular selection of the composition of the monomers and of the specific structure of said resin, to have a good ability to form aqueous dispersions which are stable on storage and which can be used in crosslinkable two-component aqueous systems. In particular, the present invention aims to obtain an organic resin bearing reactive functions capable of being emulsified by a phase inversion process. The aqueous dispersion thus obtained, due to the small size of its particles, is more stable over time than those of the prior art.

In addition, the presence of tertiary amine groups in the resin of the invention enables a self-catalyzed crosslinking reaction, without the use of catalysts based on tin-type metal derivatives, during the formation of the crosslinked product.

Among the main advantages associated with the new system according to the present invention, mention may be made of the following:

obtaining coatings equivalent to polyurethane coatings with properties inherent to this type of coating, without the use of isocyanates, in particular obtaining thick coatings without defects linked to this use and with improved health and safety conditions and with respect for the environment, and without significantly affecting the essential performance of said coating or maintaining a similar if not identical performance level to that of a comparable polyol-polyisocyanate system of the prior art, crosslinking at relatively low temperature and in particular in a range from ambient temperature to 150° C.;

obtaining high-performance two-component aqueous systems that are self-catalyzed, unlike the conventional two-component systems which use metal catalysts, and more particularly tin;

formulating coatings, in particular paints, varnishes, inks, adhesives, glues, complying with the trends in regulations in force regarding VOCs;

reducing the overall cost of the formulation compared to the polyol-isocyanate system;

rapid drying and maintenance of the good properties of the coating film obtained, despite the low VOC content;

good application performance and, in particular, in terms of durability, including in terms of corrosion, hardness/flexibility compromise, adhesion to substrate, chemical resistance and thermal resistance.

### DISCLOSURE OF THE INVENTION

The present invention therefore covers, as a first subject, a specific organic resin, a binder for crosslinkable compositions in an organic solvent medium or in an aqueous medium, bearing tertiary amine and carboxylic acid groups.

The second subject of the invention relates to an aqueous dispersion comprising a resin according to the invention, in particular without any surfactant.

The third subject of the invention relates to a process for preparing an aqueous dispersion according to the invention.

Another subject of the invention covers a two-component crosslinkable composition, comprising said resin or said aqueous dispersion of the invention, and more particularly further comprising at least one crosslinking agent chosen from epoxy resins.

The invention also covers a substrate coated with a crosslinkable coating composition according to the invention.

The invention also relates to the use of a resin or of an aqueous dispersion according to the invention in a two-component crosslinkable composition comprising an epoxy resin as crosslinking agent.

Finally, a crosslinked product, and more particularly a crosslinked coating, which results from the use of a resin or of an aqueous dispersion according to the invention, with an epoxy resin, is also part of the invention.

### DETAILED DESCRIPTION

Thus, the first object of the present invention relates to an organic resin comprising in its composition two copolymers P1 and P2, in weight proportions of P1/P2 ranging from 90/10 to 60/40, and preferably from 80/20 to 70/30, wherein at least said copolymer P1 bears at least one tertiary amine group and said copolymer P2 bears at least one carboxylic acid group.

The copolymers P1 and P2 are copolymerized with one another, preferably by radical polymerization. Thus, the copolymers P1 and P2 are not simply mixed with one another. Specifically, the copolymerization between P1 and P2 enables the formation of a plurality of covalent bonds between the copolymers P1 and P2.

The organic resin according to the invention may in particular be a multiphase polymer. The expression “multiphase polymer” is understood to denote, within the meaning of the invention, a polymer having an inhomogeneous composition. The multiphase polymer may be obtained by a process of sequential polymerization in at least two steps starting from at least two compositions (or mixtures) of different monomers. In particular, the multiphase polymer may comprise at least two phases, a first phase S1 comprising the copolymer P1 and a second phase S2 comprising the copolymer P2, the phases S1 and S2 being coupled together by a plurality of covalent bonds. The first phase S1 may in particular correspond to a hydrophobic phase. The second phase S2 may in particular correspond to a hydrophilic phase, the hydrophilic character being provided by the presence of carboxylic acid functions and optionally an alkoxylated or polyalkoxylated group.

The organic resin according to the invention may in particular be obtained by polymerizing the monomers constituting the copolymer P2 in the presence of the copolymer P1 and optionally of a radical initiator such as a peroxide. Thus, the growing chains generated during the polymerization of the copolymer P2 may be grafted onto manufactured and terminated chains of the copolymer P1. In particular, the radical initiator may remove hydrogen atoms on these chains, thus forming radicals which may be combined to create covalent bonds between the copolymers P1 and P2.

According to this particular embodiment, the multiphase polymer obtained could be rearranged after emulsification, in water, so as to obtain a structure similar to a core/shell, the first copolymer P1 forming the “core” and the second copolymer P2 forming the “shell”. This “core/shell” designation should not however be interpreted as denoting a particle in which the “core” part is completely coated or encapsulated by a “shell” part, but as denoting a particle with a controlled morphology having two distinct phases.

The expression “resin soluble in an organic medium” means that said resin has no crosslinked structure, in which case (if crosslinked) it would be insoluble in any solvent (organic medium). More precisely, the fact that said resin is soluble means that it has a linear or branched structure, which cannot be crosslinked, and which is therefore soluble in an organic medium.

According to a preferred embodiment, the copolymers P1 and P2 of the resin each bear at least one tertiary amine group.

More particularly, the copolymer P1 alone, or the two copolymers P1 and P2, bear at least one ethylenically unsaturated monomer bearing at least one tertiary amine group a), and preferably an aminoalkyl (meth)acrylate monomer in which said linear or branched alkyl comprises from 1 to 12 carbon atoms.

For the purposes of the present invention, the expression “the copolymer X bears a monomer Y” or “the copolymer X comprises a monomer Y” means that the copolymer X comprises a unit derived from the polymerization of a monomer Y. In other words, this means that the copolymer X is obtained by polymerization of a composition comprising the monomer Y.

The monomer a) may in particular be chosen from 2-dimethylaminoethyl methacrylate (DMAEMA), 2-(dimethylamino)ethyl acrylate (DMAEA), 2-diethylaminoethyl methacrylate, 2-(diethylamino)ethyl acrylate, N-(3-(N,N-dimethylamino)propyl)acrylamide, N-(3-(N,N-dimethylamino)propyl)methacrylamide, 3-(dimethylamino)propyl acrylate, 3-(dimethylamino)propyl methacrylate, 3-(diethylamino)propyl acrylate, 3-(diethylamino)propyl methacrylate, 4-(N,N-dimethylamino)styrene, 4-(N,N-diethylamino)styrene, 4-vinylpyridine, 2-dimethylaminoethyl vinyl ether, 2-diethylaminoethyl vinyl ether, 3-dimethylaminopropyl vinyl ether, 3-diethylaminopropyl vinyl ether, 4-dimethylaminobutyl vinyl ether and 6-dimethylaminohexyl vinyl ether and mixtures thereof.

Preferably, the monomer a) is chosen from 2-dimethylaminoethyl methacrylate (DMAEMA), 2-(dimethylamino)ethyl acrylate (DMAEA), 2-diethylaminoethyl methacrylate and 2-(diethylamino)ethyl acrylate.

Said monomer a) advantageously represents from 1% to 20%, and more advantageously from 5% to 15%, by weight of the total weight of said organic resin.

According to a particular embodiment, said monomer a) represents from 1% to 15%, and preferably from 5% to 15%, by weight of the total weight of said copolymer P1.

According to a particular embodiment, said monomer a) represents from 0 to 15%, and preferably from 1% to 15%, by weight of the total weight of said copolymer P2.

According to a preferred option, said monomer a) represents from 1% to 15%, and preferably from 5% to 15%, by weight of the total weight of said copolymer P1, and from 0 to 10%, and preferably from 1% to 5%, by weight of the total weight of said copolymer P2.

For the purposes of the present invention, the expression “the monomer Y represents 1% to 20% by weight of the total weight of the resin Z (or of the copolymer X)” means that the units derived from the polymerization of the monomer Y represent 1% to 20% by weight of the total weight of resin Z (or of the copolymer X)”. In other words, this means that the resin Z (or the copolymer X) are obtained by polymerization of a composition comprising 1% to 20% by weight of monomer Y relative to the total weight of the monomers in the composition.

According to another preferred embodiment, the copolymers P1 and/or P2, and preferably both P1 and P2, are acrylic, vinyl and/or vinyl-acrylic copolymers, including styrene-acrylic copolymers.

Advantageously, the copolymers P1 and/or P2, and preferably both P1 and P2, comprise at least one ethylenically unsaturated monomer b).

The monomer b) is different from the monomers a), c) d) and e). Thus, the monomer b) does not comprise a group chosen from carboxylic acid, tertiary amine, hydroxyl and alkoxylated or polyalkoxylated group.

The copolymers P1 and/or P2, and preferably both P1 and P2, may comprise a mixture of monomers b).

The monomer b) is preferably chosen from an alkyl (meth)acrylate wherein said linear or branched alkyl comprises at least 4 carbon atoms, and preferably from 4 to 36 carbon atoms, the monomers having a cycloaliphatic structure with at least 6 carbon atoms, and preferably from 6 to 18 carbon atoms, or from at least one ester of 018 to 036 fatty acids with a hydroxyalkyl (meth)acrylate or at least one ester of vinyl alcohol with at least one linear or branched acid comprising at least 6 carbon atoms, preferably at least 9 carbon atoms, and more particularly from 9 to 36 carbon atoms, acrylonitrile, vinyl esters, vinyl aromatic monomers comprising from 6 to 18 carbon atoms, such as styrene and its derivatives including (ortho, meta, para) vinyltoluenes, α-methylstyrene, tert-butylstyrene, para-butylstyrene and para-decylstyrene. Even more preferentially, said monomer b) is chosen from at least one monomer from the group composed of methyl, butyl, lauryl, isodecyl, decyl, dodecyl, stearyl, 2-ethylhexyl, isooctyl, 2-octyl, 2-octyldecyl, 2-octyldodecyl and tridecyl (meth)acrylate, esters (monoesters) of (C₃₆) fatty acid dimers with a hydroxyalkyl (meth)acrylate, the glycidyl (meth)acrylate ester of a C₁₀ branched, in particular C₁₀ highly branched, saturated carboxylic acid, such as the glycidyl (meth)acrylate ester of versatic acid, said glycidyl ester being known under the name “Cardura® E10” or the glycidyl (meth)acrylate ester of a C₉ branched, in particular C₉ highly branched carboxylic acid or the vinyl esters of a C₁₀ branched, in particular C₁₀ highly branched carboxylic acid, such as versatic acid known under the trade name VeoVa 10 or the vinyl esters of a C₉ branched, in particular C₉ highly branched, saturated carboxylic acid, known under the trade name VeoVa 9, the vinyl esters of C₁₈ fatty acids, of (C₃₆) fatty acid dimers or monomers with a cycloaliphatic structure such as isobornyl, isophoryl, tert-butylcyclohexyl or 3,3,5-trimethylcyclohexyl (meth)acrylate, cyclohexyl methacrylate, esters of a monoalkyl ester (ester-acid), wherein said linear or branched alkyl is a C₁ to C₁₈ alkyl, of an m- or p-hexahydrophthalic acid (or 1,3- or 1,4-cyclohexanedioic acid monoesterified by a C₁ to C₁₈ alkyl group) with hydroxyalkyl (meth)acrylates, and styrene and its derivatives. Said most preferred monomers b) are chosen from methyl, butyl, lauryl, isodecyl, decyl, dodecyl, stearyl, 2-ethylhexyl, isooctyl, 2-octyl, 2-octyldecyl, 2-octyldodecyl and tridecyl (meth)acrylate, and styrene and its derivatives.

Said monomer b) advantageously represents from 20% to 99%, and more advantageously from 50% to 99%, and more advantageously still from 60% to 90%, by weight of the total weight of said organic resin. Said monomer b) preferably represents from 80% to 99%, and more preferentially from 85% to 95%, by weight of the total weight of the copolymer P1. Said monomer b) preferably represents from 65% to 90%, and more preferentially from 70% to 80%, by weight of the total weight of the copolymer P2.

According to another preferred embodiment, the copolymer P2 comprises at least one ethylenically unsaturated monomer bearing at least one carboxylic acid group c).

The term “carboxylic acid group” means a —COOH group and its derivatives. The carboxylic acid derivatives are groups which can generate one or two —COOH groups by hydrolysis, in particular anhydrides (—C(═O)—O—C(═O)—). The anhydrides may be linear or cyclic.

Preferably, the monomer c) is chosen from the following monomers: (meth)acrylic acid, itaconic acid and anhydride, maleic acid and anhydride, fumaric acid, crotonic acid and anhydride, tetrahydrophthalic acid and anhydride, dicarboxylic acid hemiesters with a hydroxyalkyl (meth)acrylate wherein said linear or branched alkyl comprises from 2 to 4 carbon atoms, and may optionally be alkoxylated, in particular with an alkoxy group comprising from 2 to 4 carbon atoms, dicarboxylic acid hemiesters with a monohydroxylated polyether-mono(meth)acrylate or polyester-mono(meth)acrylate oligomer, preferably the polyether diol or polyester diol oligomers serving as a basis for these (meth)acrylated oligomers bearing a carboxylic acid function having a number-average molecular mass Mn (calculated by measuring the terminal functions) of less than 1000 and preferably less than 500.

According to a particularly preferred option, the copolymer P2 comprises at least one monomer c) selected from (meth)acrylic acid and itaconic acid, and even more preferentially (meth)acrylic acid.

According to an even more preferred embodiment, the copolymer P1 is devoid of a carboxylic acid group.

Said monomer c) advantageously represents from 0.5% to 10%, and more advantageously from 1% to 5%, by weight of the total weight of said organic resin. Said monomer c) advantageously represents from 0.5% to 10%, and more advantageously from 1% to 5%, by weight of the total weight of the copolymer P2.

According to another preferred embodiment, the copolymer P2 comprises at least one alkoxylated or polyalkoxylated group.

Advantageously, the copolymer P2 comprises at least one ethylenically unsaturated monomer bearing at least one alkoxylated or polyalkoxylated group d), and preferably an alkoxylated mono(meth)acrylate monomer or a polyalkoxylated mono(meth)acrylate monomer chosen from etheralkyl mono(meth)acrylate wherein said linear or branched alkyl preferably comprises from 1 to 12 carbon atoms (such as 2-methoxyethyl acrylate), alkoxy-polyalkylene glycol mono(meth)acrylate, and aryloxy-polyalkylene glycol mono(meth)acrylate. Even more advantageously, said monomer d) is an alkoxy-polyalkylene glycol mono(meth)acrylate monomer chosen from methoxy polyethylene glycol mono(meth)acrylate or ethoxy polyethylene glycol mono(meth)acrylate, preferably having a number-average molecular weight Mn ranging from 150 to 1000 g/mol, and more preferentially from 300 to 600 g/mol, and even more preferentially is methoxy polyethylene glycol (350) methacrylate or 2-(2-ethoxyethoxy)ethyl acrylate.

Said monomer d) preferably represents from 0 to 10%, and more preferentially from 1% to 10%, and even more preferentially from 0.5% to 5%, by weight of the total weight of said organic resin. Said monomer d) preferably represents from 0 to 10%, and more preferentially from 1% to 10%, and even more preferentially from 0.5% to 5%, by weight of the total weight of the copolymer P2.

According to an even more preferred embodiment, the copolymer P1 is devoid of an alkoxylated group or of a lateral polyalkoxylated (polyether) chain (derived from a monomer bearing said alkoxylated group or said lateral polyalkoxylated (polyether) chain).

According to another preferred embodiment, the copolymer P2 comprises at least one hydroxylated group.

Advantageously, said copolymer P2 comprises at least one ethylenically unsaturated monomer bearing at least one hydroxylated group e), and even more advantageously a monomer chosen from hydroxyethyl (meth)acrylate (HE(M)A), hydroxypropyl (meth)acrylate, and hydroxybutyl (meth)acrylate.

Said monomer e) preferably represents from 0 to 10%, and more preferentially from 0 to 5%, by weight of the total weight of said organic resin. Said monomer e) preferably represents from 0 to 10%, and more preferentially from 0 to 5%, by weight of the total weight of the copolymer P2.

The copolymers P1 and/or P2 may also comprise other optional monomers present to adjust the final performance of the resin depending on its use. They are different from the monomers a), b), c), d) and e), and may bear functional groups different from said monomers. These other optional monomers do not bear any group capable of reacting with a functional group of another component monomer of said resin, any crosslinking reaction in the preparation of said resin being excluded.

This means that the composition of the resin is chosen such that no internal (crosslinking) reaction can take place between two component monomers of said resin. In fact, no internal crosslinking reaction in said resin should take place due to a single monomer or due to two or more monomers which react with one another. Specifically, by definition, said resin is soluble in an organic medium and therefore cannot be in crosslinked form in its internal structure.

As examples of other optional monomers, mention may be made of the following monomers, on condition that there is a differentiation with respect to the monomers a), b), c), d) and e): monomers bearing an amide group such as acrylamide, monomers bearing a ureido group, monomers bearing acetoacetoxy groups, ethylenically unsaturated monomers comprising a linear or branched aliphatic group having fewer than 4 carbon atoms.

The copolymer P1 is preferably devoid of any hydroxylated group.

According to a preferred embodiment of the invention, the resin of the invention is devoid of any anhydride group.

The copolymer P1 is advantageously more hydrophobic than the copolymer P2.

For the purposes of the invention, a “hydrophobic” polymer is understood to mean a polymer comprising hydrophobic monomers, that is to say having little affinity with water or which is sparingly soluble in water. One method for estimating this hydrophobicity is that of measuring the partition coefficient of the substance to be evaluated, between octanol and water, with the hydrophobicity expressed as a logarithm of this partition coefficient. The hydrophobicity value log Kow for a monomer is an estimation calculated from the logarithm of the partition coefficient (log P) between octanol and water, via the method of contribution of the atoms and the structural fragments of the molecule, using for this estimation the EPI (Estimation Program Interface) Suite® software known as KowWin from SRC (Syracuse Research Corporation). The method and program epi 4.11 used for this calculation (estimation) of log Kow for the monomers are available at the address http://www.epa.gov/oppt/exposure/pubs/episuite.htm. This methodology is described by W. M. Meylan and P. H. Howard in 1995 in “Atom/fragment contribution method for estimating octanol-water partition coefficients” in Pharm. Sci. 84: 83-92. The partition coefficient P corresponds to the ratio of the chemical concentration in the octanol phase relative to the chemical concentration in the aqueous phase in a system with two phases in equilibrium. As regards a copolymer, in particular such as a resin defined according to the invention, the overall hydrophobicity value according to the invention based on the logarithm of the octanol/water partition coefficient is defined as being the mean weight value relative to all of the component monomers of the resin and it is in particular estimated by the mean weight relative to all of the component monomers, from the individual log Kow values calculated via the KowWin method, as described above.

Thus, the difference in hydrophobicity between P1 and P2, expressed as logarithm of the octanol/water partition coefficient, in particular as log Kow according to the KowWin method described above, is at least 0.15 units, and preferably at least 0.25 units, and even more preferentially at least 0.30 units, and P1 having an acid number of zero or significantly zero or significantly lower than that of P2.

According to a preferred embodiment of the invention, the copolymers P1 and P2 have different glass transition temperatures, preferably with P2 having a higher Tg than P1, in particular at least 5° C. higher, and preferably at least 10° C. higher than the Tg of P1. The copolymer P1 preferably has a glass transition temperature ranging from −40° C. to 120° C., and the copolymer P2 preferably has a glass transition temperature ranging from −35° C. to 125° C.

The resin of the invention advantageously has an acid value of at least 5, and preferably ranging from 10 to 60 mg KOH/g.

The resin of the invention advantageously has an amine value of at least 3, and preferably ranging from 5 to 50 mg KOH/g.

The resin of the invention preferably has a number-average molecular mass Mn, measured by GPC (as polystyrene equivalent, in THF) ranging from 500 to 20 000 g/mol, and preferably from 1000 to 8000 g/mol.

The resin of the invention preferably has a weight-average molecular mass Mw, measured by size exclusion chromatography, ranging from 5000 to 50 000 g/mol, and preferably from 10 000 to 20 000 g/mol.

The resin of the invention may be in the form of a solution in at least one organic diluent, preferably polar organic diluent having a weight content of resin ranging from 70% to 98%, and preferably ranging from 80% to 95%. Thus, the organic diluent preferably bears at least one polar group.

Mention may be made, as suitable examples of such diluents, of those comprising ester, ether, sulfoxide, amide, alcohol, ketone or aldehyde groups. The organic diluent is preferably chosen from glycol ethers, and more preferentially from ethylene glycol, propylene glycol, dipropylene glycol, and butyl glycol. Said diluent must not react with the functional groups borne by the resin of the invention.

The resin of the invention is advantageously self-dispersible in water after neutralization, without the need for addition of surfactant or dispersant. The term “self-dispersible resin” means a resin capable of dispersing spontaneously in a basic aqueous phase under gentle stirring. This ability is in particular due to the presence of ionizable groups on the resin, in particular to the presence of carboxylic acid groups which can be neutralized by addition of a base.

Thus, the second subject of the invention relates to an aqueous resin dispersion, which dispersion comprises at least one resin as defined according to the invention in water-dispersed form, said resin being partially or completely neutralized. Completely or partially neutralized refers to the carboxylic acid group of said resin. According to a particular preference, said aqueous dispersion is devoid of any surfactant. This means that said resin is able, by virtue of its composition and specific structure, to form a stable dispersion without the need for any surfactant.

The neutralization can be carried out with an organic base, which under the neutralization conditions selectively neutralizes the carboxylic acid groups of said resin without adversely affecting the other groups of said resin. The neutralizing agent is preferably an organic amine, more preferentially a secondary amine (such as diethanolamine, N-methylethanolamine, dimethylamine, dibutylamine) or a tertiary amine, and even more preferentially bears at least one hydroxy group, such as for example dimethylaminoethanol (DMAE) or triethanolamine (TEOH).

According to a preferred embodiment, the dispersion of the invention is partially neutralized with a degree of neutralization of at least 40%, and preferably of at least 50%, of the carboxylic acid groups of said resin.

The aqueous dispersion of the invention is advantageously devoid of surfactant and of dispersant.

In the dispersion of the invention, the polymer particles advantageously measure from 50 to 300 nm, more advantageously from 80 to 200 nm, and even more advantageously from 100 to 150 nm. The size of the polymer particles is measured by dynamic light scattering.

The dispersion of the invention can have a solids content ranging from 30% to 60%, and preferably from 40% to 60%. This content can be measured according to the ISO 3251 method.

The Brookfield viscosity of the aqueous dispersion of the invention, measured at 25° C., preferentially ranges from 50 to 1500 mPa·s, more preferentially from 200 to 1000 mPa·s, and even more preferentially from 400 to 800 mPa·s. Such a viscosity enables easy formulation of the final two-component crosslinkable composition, without adversely affecting its application conditions.

A third subject of the present invention relates to a process for preparing an aqueous resin dispersion according to the invention comprising the following steps:

i—preparing a resin according to the invention in solution in at least one organic diluent, and preferably in at least one polar organic diluent,

ii—partially or completely neutralizing the carboxylic acid groups of said resin, preferably by adding an amine, and more preferentially by adding a solution of dimethylaminoethanol (DMAE) or of triethanolamine (TEOH), without adversely affecting the other groups of said resin,

iii—preparing an aqueous dispersion of said resin by adding water until phase inversion, preferably at a temperature ranging from 50° C. to 80° C.

In the process of the invention, said resin may be an acrylic, vinyl or vinyl-acrylic resin, including styrene-acrylic resin, and in this case step i—of preparing said resin is carried out by radical polymerization in a solvent medium.

More particularly, step i—of preparing said resin comprises the preparation of said copolymers P1 and P2 in two successive steps i1- and i2—in the same reactor:

i1—preparing, in solution, a first copolymer P1 as defined according to the invention, and

i2—preparing a second copolymer P2 as defined according to the invention, in the same reactor already containing said first copolymer P1,

said copolymers P1 and P2 being subsequently copolymerized with one another, preferably by radical polymerization.

The process of the invention may also comprise an additional step iv—of removing the organic diluent, preferably by steam stripping or stripping with an inert gas.

The process of the invention may also comprise an additional step v—of adjusting the final dilution of said aqueous dispersion with respect to the targeted final solids content.

The present invention also relates to a two-component crosslinkable composition, and more particularly to a two-component crosslinkable coating composition, devoid of isocyanate comprising at least one resin according to the invention or at least one aqueous dispersion according to the invention, in an organic solvent medium or in an aqueous medium, and preferably in an aqueous medium.

According to a preferred embodiment, said two-component crosslinkable composition comprises at least one resin according to the invention or at least one aqueous dispersion according to the invention, and an epoxy resin as crosslinking agent. Advantageously, the two-component crosslinkable composition of the invention is a two-component reactive composition comprising an epoxy resin in aqueous dispersion or diluted in water. Said epoxy resin reacts with the resin of the invention during its addition to evolve irreversibly over time toward a crosslinked coating forming a polymer network of infinite molecular mass and of three-dimensional structure. Therefore, the epoxy crosslinking agent will be added just prior to the end use and application of the crosslinkable coating composition.

The epoxy resin used as crosslinking agent in the two-component reactive composition of the invention advantageously has an epoxy content of greater than 5 mg KOH/g, and even more advantageously greater than 15 mg KOH/g. The solids content of said epoxy resin advantageously varies from 30% to 100%.

The two-component crosslinkable composition of the invention is advantageously devoid of catalyst based on metal derivatives.

According to a particularly preferred case, said two-component crosslinkable composition of the invention comprises an organic diluent for said resin in solution and said diluent is reactive with said epoxy resin (crosslinking agent) as defined above.

Said resin advantageously comprises at least one monomer selected from ethylene oxide, propylene oxide, glycidyl (meth)acrylate, the reaction product of an epihalohydrin such as epichlorohydrin with a polyhydric alcohol or a phenol such as bisphenol A or bisphenol F.

Said epoxy resin can be added to the two-component crosslinkable composition, either as is and be dispersed/solubilized in said composition, or in the form of a preformed aqueous dispersion or solution.

According to a preferred embodiment of the invention, the two-component crosslinkable composition is a coating composition from among paint, varnish, ink, adhesive, glue, and preferably an aqueous coating composition chosen from aqueous paint or varnish compositions.

Another subject of the invention relates to a substrate coated with a two-component crosslinkable composition according to the invention, said substrate preferably being chosen from substrates made of metal, glass, wood, including chipboard and plywood, plastic, metal, concrete, plaster, composite, textile.

The present invention also relates to the use of a resin according to the invention or of an aqueous dispersion according to the invention, in a two-component crosslinkable composition comprising an epoxy resin as crosslinking agent. More particularly, the invention targets the use of a resin according to the invention or of an aqueous dispersion according to the invention, for the preparation of a two-component crosslinkable composition chosen from aqueous coating compositions, preferably aqueous paint, varnish, ink, adhesive or glue compositions, and even more preferentially aqueous paint or varnish compositions.

In this use, said two-component crosslinkable compositions may be protective coating compositions, in particular top coating compositions or corrosion-resistant coating compositions, or decorative coating compositions. These coating compositions have performance properties of high resistance to wear and to abrasion and/or to intensive use in severe weather conditions of continuous external use and are particularly suitable for applications in the following fields: railroad renovation and construction, motor vehicles, road transport, naval, aeronautics, agricultural machinery, public works machinery, wind turbines, oil platforms, containers, metal structures, metal frames, coils or buildings including furniture, wooden flooring, carpentry and frameworks.

Finally, the last subject of the invention targets the final crosslinked product obtained. It is a crosslinked product resulting from the use of a resin according to the invention or of an aqueous dispersion according to the invention, with an epoxy resin as crosslinking agent.

In addition to the foregoing arrangements, the invention also comprises other arrangements which will emerge from the rest of the description which follows, which relates to examples of synthesis of organic resins and of aqueous dispersions of resins according to the invention, and to comparative examples, and also to the evaluation thereof in two-component crosslinkable compositions.

### EXAMPLES

Measurement Methods

In the present patent application, the following measurement methods were used:

Measurement of the solids content of the organic resin: according to ISO 3251: 2019 (1 g of resin in solution for 1 hour at 125° C.).

Resin acid value: according to ISO 2114: 2000 (expressed in mg of KOH per g of dry resin).

Measurement of number-average molecular weights Mn and weight-average molecular weights Mw: by GPC in THF with calibration based on monodisperse polystyrene standards, with Mn expressed as polystyrene equivalents. The measurement conditions were the following:

Columns based on crosslinked polystyrene-divinylbenzene (PS-DVB) gel (2 MIXED-D columns (ref. 1110-6504)+1 100 Å column (ref 1110-6520)+1 50 Å column (ref. 1110-6515), (7.8 mm)×300 mm) sold by Agilent

Eluent: THF

Mobile phase (THF) flow rate: 1 ml/min,

T°: 35° C.,

RI detection

Calibration: PS standards (Mw: 465 600, 364 000, 217 000, 107 100, 45 120, 19 500, 9570, 4750, 3090, 1230, 580, 162 g/mol).

Measurement of the pH of the emulsion: measured according to the ISO 976: 2013 standard.

Measurement of the viscosity of the aqueous dispersions: measured on a Brookfield viscometer (according to the ISO 2555: 2018 standard) at a temperature of 25° C.

Average particle size and polydispersity index: measured by light diffraction according to the ISO 22412: 2017 standard.

Persoz hardness: The Persoz hardness is measured after application with a film applicator of a wet paint composition with a thickness of 350 μm on a QD46 steel plate (in an air-conditioned room at 23° C. and 50% relative humidity). The Persoz hardness is measured using a pendulum for 14 days according to standard NF EN ISO 1522 March 2007 (in an air-conditioned room at 23° C. and 50% relative humidity).

20°/60° gloss: The gloss is measured after application with a film applicator of a wet paint composition with a thickness of 350 μm on a QD412 steel plate (in an air-conditioned room at 23° C. and 50% relative humidity) and drying for 24 hours. The measurements of gloss at 20° and 60° are carried out according to standard NF EN ISO 2813 September 1999 (in an air-conditioned room at 23° C. and 50% relative humidity).

Dry thickness: The dry thickness is measured after application with a film applicator of a wet paint composition with a thickness of 350 μm on different types of plates: QD412 steel plate, QD46 steel plate and S46 steel plate (in an air-conditioned room at 23° C. and 50% relative humidity) and drying for 24 hours. The dry thickness measurements are carried out according to standard NF EN ISO 288 April 2007. The results presented are an average of five measurements.

Dust-free drying time: The dust-free drying time is measured after application with a film applicator of a wet paint composition with a thickness of 350 μm on a QD412 steel plate (in an air-conditioned room at 23° C. and 50% relative humidity). Fifteen minutes after application, the film is brought into contact with glass beads at various times, then dusted with a brush until the beads are completely detached from the surface of the paint, to determine the dust-free drying time of the paint according to standard NF EN ISO 1517 June 1995.

Chemical resistance: The chemical resistance is evaluated after application with a film applicator of a wet paint composition with a thickness of 350 μm on a S46 steel plate (in an air-conditioned room at 23° C. and 50% relative humidity). The chemical resistance is measured using a Taber© linear abrasion tester after drying the film for a week in an air-conditioned room at 23° C. and 50% relative humidity. The methyl ethyl ketone (MEK) resistance of the paint film is evaluated by the time required (in seconds) for the wear of the surface of the paint with a weight of one kilogram equipped with a cotton wick soaked in MEK performing back and forth movements on the coating to be tested, until the paint is completely destroyed.

### Example 1: Preparation of an Organic Resin According to the Invention and of an Aqueous Dispersion Comprising Said Resin

Synthesis of the Organic Resin of the Invention:

180 g of 2-butoxyethanol and 78 g of polypropylene glycol (Mn=1000 g/mol) are introduced into a 2-liter reactor. The reactor is then brought to 150° C. under a nitrogen purge. At the same time, 465 g of styrene, 292.5 g of methyl methacrylate, 213 g of butyl acrylate, 42 g of lauryl methacrylate, and 112.5 g of 2-dimethylaminoethyl methacrylate are mixed to form a copolymer P1 having Tg=41.2° C. A solution of 33.8 g of di-tert-butyl peroxide (DTBP) and 16.9 g of tert-butyl peroctoate (TBPO) in 50.6 g of 2-butoxyethanol is also prepared. These two preparations are then introduced simultaneously into the reactor, over a period of 3 hours at 150° C.

At the end of these additions, the medium is kept at the same temperature for 30 minutes, before being cooled to 135° C.

At the same time, a mixture of 90 g of styrene, 84 g of methyl methacrylate, 93 g of butyl acrylate, 13.5 g of lauryl methacrylate, 42 g of acrylic acid, 37.5 g of 2-dimethylaminoethyl methacrylate and 15 g of methoxy polyethylene glycol monomethacrylate (to form a copolymer P2 having Tg=23.8° C.), and also a solution of 11.25 g of DTBP and 5.63 g of TBPO in 16.88 g of 2-butoxyethanol are prepared.

The two preparations of copolymers P1 and P2 are introduced into a reactor at 135° C. over a period of 2 hours. The temperature is then kept constant at 135° C. for an additional 1 hour.

The solids content of the organic resin obtained is 84.7%, its acid value is 24.2 mg of KOH/g, and its calculated amine value is 35.7 mg of KOH/g. The number-average molecular mass Mn of this resin, measured by GPC, with THF as solvent and with calibration using monodisperse polystyrenes, is 2400 g/mol.

Preparation of an Aqueous Dispersion Comprising the Organic Resin of the Invention:

567.4 g of the organic resin thus prepared is partially neutralized by the addition of 111 mL of a 10 vol % solution of dimethylethanolamine in water over a period of 10 minutes. During this step, the temperature goes from 70° C. to 65° C., and the stirring speed is set at 150 rpm (revolutions per minute). After 15 minutes of stirring at 65° C., 440 g of water are introduced over 45 minutes at a stirring speed of 250 rpm (revolutions per minute), with phase inversion during this addition. The aqueous dispersion obtained is then diluted with water to obtain a solids content of 43.6%, a pH of 9.1, a viscosity of 600 mPa·s, and a measured particle size of 142 nm with a polydispersity index of 0.041.

The composition of the organic resin of example 1 of the invention is summarized in Table 1 below (the amounts are expressed in % by weight):

TABLE 1

| | Copolymer P1 | Copolymer P2 | Organic resin |
|---|---|---|---|
| Monomers | wt % P1 | wt % P2 | wt % |
| | (relative to the | (relative to the | (relative to the |
| | total weight of | total weight of | total weight of |
| | monomers) | monomers) | monomers) |
| Styrene | 31.0 | 6.0 | 37.0 |
| Butyl acrylate | 14.2 | 6.2 | 20.4 |
| Methyl methacrylate | 19.5 | 5.6 | 25.1 |
| 2-Dimethylaminoethyl | 7.5 | 2.5 | 10.0 |
| methacrylate | | | |
| Lauryl methacrylate | 2.8 | 0.9 | 3.7 |
| Acrylic acid | 0 | 2.8 | 2.8 |
| Methoxy-polyethylene | 0 | 1.0 | 1.0 |
| glycol monomethacrylate | | | |
| (SR550 from Sartomer) | | | |

### Example 2: Preparation of an Organic Resin According to the Invention (without 2-Dimethylaminoethyl Methacrylate in the Copolymer P2) and of an Aqueous Dispersion Comprising Said Resin

Synthesis of the Organic Resin of the Invention:

168 g of 2-butoxyethanol and 72.8 g of polypropylene glycol (Mn=1000) are introduced into a 2-liter reactor. The reactor is then brought to 150° C. under a nitrogen purge. At the same time, 420 g of styrene, 266 g of methyl methacrylate, 184.8 g of butyl acrylate, 39.2 g of lauryl methacrylate, and 140 g of 2-dimethylaminoethyl methacrylate are mixed to form a copolymer P1 having Tg=44.6° C. A solution of 31.5 g of di-tert-butyl peroxide (DTBP) and 15.8 g of tert-butyl peroctoate (TBPO) in 47.25 g of 2-butoxyethanol is also prepared. These two preparations are then introduced simultaneously into the reactor, over a period of 3 hours at 150° C.

At the end of these additions, the medium is kept at the same temperature for 30 minutes, before being cooled to 135° C.

At the same time, a mixture of 95.8 g of styrene, 85.4 g of methyl methacrylate, 100.98 g of butyl acrylate, 12.6 g of lauryl methacrylate, 39.2 g of acrylic acid, and 14 g of methoxy polyethylene glycol monomethacrylate (to form a copolymer P2 having Tg=24.7° C.), and also a solution of 10.5 g of DTBP and 5.25 g of TBPO in 15.75 g of 2-butoxyethanol are prepared.

The two preparations of copolymers P1 and P2 are introduced into a reactor at 135° C. over a period of 2 hours. The temperature is then kept constant at 135° C. for an additional 1 hour.

The solids content of the organic resin obtained is 85.3%, its acid value is 27.0 mg of KOH/g, and its calculated amine value is 35.7 mg of KOH/g. The number-average molecular mass Mn of this resin, as measured by GPC, with THF as solvent and with calibration using monodisperse polystyrenes, is 3750 g/mol.

Preparation of an Aqueous Dispersion Comprising the Organic Resin of the Invention:

407 g of the organic resin thus prepared is partially neutralized by the addition of 86.92 mL of a 10 vol % solution of dimethylethanolamine in water over a period of 10 minutes. During this step, the temperature goes from 90° C. to 65° C., and the stirring speed is set at 150 rpm (revolutions per minute). After 15 minutes of stirring at 65° C., 291.69 g of water are introduced over 45 minutes at a stirring speed of 250 rpm (revolutions per minute), with phase inversion during this addition. The aqueous dispersion obtained is then diluted with water to obtain a solids content of 45.5%, a pH of 8.3, a viscosity of 230 mPa·s, and a measured particle size of 184 nm with a polydispersity index of 0.036.

The composition of the organic resin of example 2 of the invention is summarized in Table 2 below (the amounts are expressed in % by weight):

TABLE 2

| | Copolymer P1 | Copolymer P2 | Organic resin |
|---|---|---|---|
| Monomers | wt % P1 | wt % P2 | wt % |
| | (relative to the total | (relative to the total | (relative to the |
| | weight of | weight of | total weight of |
| | monomers) | monomers) | monomers) |
| Styrene | 30.0 | 7.0 | 37.0 |
| Butyl acrylate | 13.2 | 7.2 | 20.4 |
| Methyl methacrylate | 19.0 | 6.1 | 25.1 |
| 2-Dimethylaminoethyl methacrylate | 10.0 | 0 | 10.0 |
| Lauryl methacrylate | 2.8 | 0.9 | 3.7 |
| Acrylic acid | 0 | 2.8 | 2.8 |
| Methoxy-polyethylene glycol | 0 | 1 | 1.0 |
| monomethacrylate | | | |
| (SR550 from Sartomer) | | | |

### Example 3: Preparation of a Comparative Organic Resin (Devoid of 2-Dimethylaminoethyl Methacrylate) and of an Aqueous Dispersion Comprising Said Resin

Synthesis of the Comparative Organic Resin:

168 g of 2-butoxyethanol and 72.8 g of polypropylene glycol (Mn=1000 g/mol) are introduced into a 2-liter reactor. The reactor is then brought to 150° C. under a nitrogen purge. At the same time, 484.4 g of styrene, 304.6 g of methyl methacrylate, 221.8 g of butyl acrylate, and 39.2 g of lauryl methacrylate are mixed to form a copolymer P1 having Tg=41.2° C. A solution of 31.5 g of di-tert-butyl peroxide (DTBP) and 15.8 g of tert-butyl peroctoate (TBPO) in 47.25 g of 2-butoxyethanol is also prepared.

These two preparations are then introduced simultaneously into the reactor, over a period of 3 hours at 150° C.

At the end of these additions, the medium is kept at the same temperature for 30 min, before being cooled to 135° C.

At the same time, a mixture of 95.8 g of styrene, 89.4 g of methyl methacrylate, 98.98 g of butyl acrylate, 12.6 g of lauryl methacrylate, 39.2 g of acrylic acid, and 14 g of methoxy polyethylene glycol monomethacrylate (to form a copolymer P2 having Tg=23.8° C.), and also a solution of 10.5 g of DTBP and 5.25 g of TBPO in 15.75 g of 2-butoxyethanol are prepared.

The two preparations of copolymers P1 and P2 are introduced into a reactor at 135° C. over a period of 2 hours. The temperature is then kept constant at 135° C. for an additional 1 hour.

The solids content of the organic resin obtained is 85.8%, and its acid value is 24 mg of KOH/g. The number-average molecular mass Mn of this resin, measured by GPC, with THF as solvent and with calibration using monodisperse polystyrenes, is 5400 g/mol.

Preparation of an Aqueous Dispersion Comprising the Comparative Organic Resin:

416 g of the organic resin thus prepared is partially neutralized by the addition of 81.63 mL of a 10 vol % solution of dimethylethanolamine in water over a period of 10 minutes. During this step, the temperature goes from 90° C. to 65° C., and the stirring speed is 150 rpm (revolutions per minute). After 15 minutes of stirring at 65° C., 332.43 g of water are introduced over 45 minutes at a stirring speed of 250 rpm (revolutions per minute), with phase inversion during this addition. The aqueous dispersion obtained is then diluted with water to obtain a solids content of 45.7%, a pH of 7.6, a viscosity of 95 mPa·s, and a measured particle size of 195 nm with a polydispersity index of 0.014.

The composition of the organic resin of comparative example 2 is summarized in Table 3 below (the amounts are expressed in % by weight):

TABLE 3

| | Copolymer P1 | Copolymer P2 | Organic resin |
|---|---|---|---|
| Monomers | wt % P1 | wt % P2 | wt % |
| | (relative to the total | (relative to the | (relative to the |
| | weight of | total weight of | total weight of |
| | monomers) | monomers) | monomers) |
| Styrene | 34.6 | 6.8 | 41.4 |
| Butyl acrylate | 15.8 | 7.1 | 22.9 |
| Methyl methacrylate | 21.8 | 6.4 | 28.2 |
| 2-Dimethylaminoethyl methacrylate | 0 | 0 | 0 |
| Lauryl methacrylate | 2.8 | 0.9 | 3.7 |
| Acrylic acid | 0 | 2.8 | 2.8 |
| Methoxy-polyethylene glycol | 0 | 1.0 | 1.0 |
| monomethacrylate | | | |
| (SR550 from Sartomer) | | | |

### Example 4: Preparation of a Comparative Organic Resin (without 2-Dimethylaminoethyl Methacrylate in the Copolymer P1) and of an Aqueous Dispersion Comprising Said Resin

Synthesis of the Comparative Organic Resin:

168 g of 2-butoxyethanol and 72.8 g of polypropylene glycol (Mn=1000) are introduced into a 2-liter reactor. The reactor is then brought to 150° C. under a nitrogen purge. At the same time, 462 g of styrene, 308 g of methyl methacrylate, 240.8 g of butyl acrylate, and 39.2 g of lauryl methacrylate are mixed to form a copolymer P1 having Tg=41.2° C. A solution of 31.5 g of di-tert-butyl peroxide (DTBP) and 15.8 g of tert-butyl peroctoate (TBPO) in 47.25 g of 2-butoxyethanol is also prepared. These two preparations are then introduced simultaneously into a reactor, over a period of 3 hours at 150° C.

At the end of these additions, the medium is kept at the same temperature for 30 min, before being cooled to 135° C.

At the same time, a mixture of 56 g of styrene, 43.4 g of methyl methacrylate, 44.8 g of butyl acrylate, 12.6 g of lauryl methacrylate, 39.2 g of acrylic acid, 140 g of 2-dimethylaminoethyl methacrylate and 14 g of methoxy polyethylene glycol monomethacrylate (to form a copolymer P2 having Tg=23.8° C.), and also a solution of 10.5 g of DTBP and 5.25 g of TBPO in 15.75 g of 2-butoxyethanol are prepared.

The two preparations of copolymers P1 and P2 are introduced into a reactor at 135° C. over a period of 2 hours. The temperature is then kept constant at 135° C. for an additional 1 hour.

The solids content of the resin obtained is 85.3%, its acid value is 23.6 mg of KOH/g, and its calculated amine value is 35.7 mg of KOH/g. The number-average molecular mass Mn of this resin, measured by GPC, with THF as solvent and with calibration using monodisperse polystyrenes, is 3300 g/mol.

Preparation of an Aqueous Dispersion Comprising the Comparative Organic Resin:

415.5 g of the organic resin thus prepared is partially neutralized by the addition of 79.09 mL of a 10 vol % solution of dimethylethanolamine in water over a period of 10 minutes. During this step, the temperature goes from 90° C. to 65° C., and the stirring speed is 150 rpm (revolutions per minute). After 15 minutes of stirring at 65° C., 337.38 g of water are introduced over 45 minutes at a stirring speed of 250 rpm (revolutions per minute), with phase inversion during this addition. The aqueous dispersion obtained is then diluted with water to obtain a solids content of 45.4%, a pH of 9, a viscosity of 1650 mPa·s, and a measured particle size of 214 nm with a polydispersity index of 0.085.

The composition of the organic resin of comparative example 4 is summarized in Table 4 below (the amounts are expressed in % by weight):

TABLE 4

| | Copolymer P1 | Copolymer P2 | Organic resin |
|---|---|---|---|
| Monomers | wt % P1 | wt % P2 | wt % |
| | (relative to the total | (relative to the total | (relative to the |
| | weight of | weight of | total weight of |
| | monomers) | monomers) | monomers) |
| Styrene | 33.0 | 4.0 | 37.0 |
| Butyl acrylate | 17.2 | 3.2 | 20.4 |
| Methyl methacrylate | 22.0 | 3.1 | 25.1 |
| 2-Dimethylaminoethyl methacrylate | 0 | 10.0 | 10.0 |
| Lauryl methacrylate | 2.8 | 0.9 | 3.7 |
| Acrylic acid | 0 | 2.8 | 2.8 |
| Methoxy-polyethylene glycol | 0 | 1.0 | 1.0 |
| monomethacrylate | | | |
| (SR550 from Sartomer) | | | |

### Example 5: Stability Test of the Aqueous Dispersions Prepared after Accelerated Aging in an Oven at 50° C.

The stability of the aqueous dispersions of examples 1, 2, 3 and 4 was evaluated by pouring samples of each of the dispersions into 25 mL glass vials, then placed in the oven for 15 days at 50° C. The particle size of the aqueous dispersions was measured after 15 days, by light diffraction according to the ISO 13321 standard indicated above.

The results of the stability test are presented in table 5 below:

TABLE 5

| | Initial particle | Particle size after aging |
|---|---|---|
| Aqueous dispersions | size (nm) | (15 days/50° C.) |
| Aqueous dispersion of example | 142 | 142 |
| 1 | | |
| Aqueous dispersion of example | 184 | 199 |
| 2 | | |
| Aqueous dispersion of example | 195 | 209 |
| 3 | | |
| Aqueous dispersion of example | 214 | 257 |
| 4 | | |

The aqueous dispersion of example 1 remains stable for one month at 50° C. (no change in the particle size after one month), while the aqueous dispersions of examples 2 and 3 have particle sizes which increase after accelerated aging, while remaining acceptable. The particle size of the aqueous dispersion of example 4 increases significantly; the latter is therefore less stable than the other aqueous dispersions.

### Example 6: Preparation of Aqueous Compositions of Two-Component Crosslinkable Coatings (Paint Compositions 1 to 4) Comprising the Aqueous Dispersions of Examples 1 to 4

The two-component crosslinkable paint compositions are summarized in Table 6 below (the amounts are expressed in % by weight):

TABLE 6

| | | | Composition | Composition | Composition | Composition |
|---|---|---|---|---|---|---|
| Starting | | | 1 | 2 | 3 | 4 |
| materials | Suppliers | Functions | (weight in g) | (weight in g) | (weight in g) | (weight in g) |
| Demineralized | — | Solvent | 10.05 | 12.64 | 12.96 | 12.58 |
| water | | | | | | |
| DYSPERBYK | BYK | Dispersant | 2.38 | 2.37 | 2.39 | 2.39 |
| 190 | | | | | | |
| BYK 024 | BYK | Antifoaming | 0.10 | 0.10 | 0.10 | 0.10 |
| | | agent | | | | |
| TIONA 595 | CRISTAL | TiO₂ pigment | 21.66 | 21.61 | 21.70 | 21.73 |
| Aqueous | — | — | 59.01 | — | — | — |
| dispersion of | | | | | | |
| example 1 | | | | | | |
| Aqueous | — | — | — | 56.11 | — | — |
| dispersion of | | | | | | |
| example 2 | | | | | | |
| Aqueous | — | — | — | — | 56.09 | — |
| dispersion of | | | | | | |
| example 3 | | | | | | |
| Aqueous | — | — | — | — | — | 56.57 |
| dispersion of | | | | | | |
| example 4 | | | | | | |
| BYK 333 | BYK | Surfactant | 0.25 | 0.25 | 0.25 | 0.25 |
| COAPUR XS | COATEX | Polyurethane | 2.20 | 2.20 | 2.21 | 2.21 |
| 71 | | thickener | | | | |
| DER 917 | DOW | Epoxy resin | 4.35 | 4.72 | 4.31 | 4.18 |
| TOTAL | | | 100 | 100 | 100 | 100 |

Procedure for the Preparation of the Paint Compositions:

Grinding Base:

First, a grinding base is prepared in a jacketed tank provided with a mains water cooling system, by adding successively with stirring, and in the following order: a portion of the demineralized water (4.5 g), the DYSPERBYK 190, and the BYK 024. The TIONA 595 is then added gradually, with vigorous stirring at 1000 rpm (revolutions per minute), then dispersed for 20 minutes at 3000 rpm. The grinding base is then left to stand for 30 minutes.

Part A of the Two-Component System:

The aqueous resin dispersion prepared above is poured into a container, at room temperature (20° C.), while stirring so as to obtain a vortex, then added in the following order are: the BYK 033, the previously prepared grinding base, and the COAPUR XS 71. The mixture is then left to stand for 24 hours.

Part B of the Two-Component System:

To form the final paint composition, the epoxy resin DER 917 is added slowly to part A previously prepared, with moderate stirring, then adjusted by adding the remaining amount of water. The mixture is left stirring for 10 minutes, followed by 30 minutes at rest, before application to a support using an automatic applicator.

Persoz Hardness Results:

The results of monitoring the hardness of the crosslinked paint coatings are summarized in Table 7 below:

TABLE 7

| | | Persoz hardness (s) | | | |
|---|---|---|---|---|---|
| Paint | Dry thickness of the film | at 1 | at 4 | at 7 | at 14 |
| compositions | (μm) | day | days | days | days |
| Composition 1 | 78 | 39 | 82 | 101 | 111 |
| Composition 2 | 80 | 33 | 79 | 92 | 100 |
| Composition 3 | 81 | 29 | 51 | 65 | 73 |
| Composition 4 | 80 | 43 | 73 | 85 | 89 |

Gloss, Drying and Chemical Resistance Results:

The gloss, drying and chemical resistance results of the crosslinked paint coatings obtained from compositions 1 to 4 are summarized in Table 8 below:

TABLE 8

| | Application on QD412 | | | Application on S46 | |
|---|---|---|---|---|---|
| | steel plate | | | steel plate | |
| | 20°/ | Dry | Dust-free | Dry | Chemical |
| Paint | 60° | thickness | drying | thickness | resistance |
| compositions | gloss | (μm) | time (min) | (μm) | (in seconds) |
| Composition 1 | 85/93 | 80 | 35 | 74 | 100-120 |
| Composition 2 | 87/94 | 75 | 36 | 77 | 100-120 |
| Composition 3 | 91/97 | 80 | 48 | 75 | 5 |
| Composition 4 | 81/93 | 80 | 36 | 74 | 10 |

The crosslinked paint coatings obtained from compositions 1 and 2 exhibit a good visual appearance with good film formation and good gloss. In addition, these are the coatings which exhibit the best mechanical properties and the best chemical resistance.

These films which are representative of the invention do not, moreover, exhibit any pinholes (blistering), after evaluation according to the ISO 4628-2 standard.

### Example 7: Preparation of a Comparative Resin Comprising a Physical Mixture of Copolymers P1 and P2 (Absence of Copolymerization)

The aim of this test is to synthesize the copolymers P1 and P2 separately and then to mix them in the ratio described in the examples of the invention: namely 75% by weight of P1 and 25% by weight of P2. It will then be a matter of verifying whether the polymer obtained after mixing the two copolymers can be emulsified in water according to the process described in the invention and whether the latter makes it possible to obtain emulsions which are stable over time.

Synthesis of the Organic Resin P1:

180 g of 2-butoxyethanol and 78 g of polypropylene glycol (Mn=1000 g/mol) are introduced into a 2-liter reactor. The reactor is then brought to 150° C. under a nitrogen purge. At the same time, 620.10 g of styrene, 390 g of methyl methacrylate, 283.95 g of butyl acrylate, 55.95 g of lauryl methacrylate, and 150 g of 2-dimethylaminoethyl methacrylate are mixed to form a copolymer P1 having Tg=41.2° C. A solution of 45 g of di-tert-butyl peroxide (DTBP) and 22.5 g of tert-butyl peroctoate (TBPO) in 67.5 g of 2-butoxyethanol is also prepared. These two preparations are then introduced simultaneously into the reactor, over a period of 3 hours at 150° C.

At the end of these additions, the medium is kept at the same temperature for 1 hour, before being cooled.

The solids content of the organic resin obtained is 83.4%.

Synthesis of the Organic Resin P2:

180 g of 2-butoxyethanol and 78 g of polypropylene glycol (Mn=1000 g/mol) are introduced into a 2-liter reactor. The reactor is then brought to 135° C. under a nitrogen purge. At the same time, 360 g of styrene, 336 g of methyl methacrylate, 372 g of butyl acrylate, 54 g of lauryl methacrylate, 168 g of acrylic acid, 150 g of 2-dimethylaminoethyl methacrylate and 15 g of methoxy polyethylene glycol monomethacrylate are mixed (in order to form a copolymer P2 having Tg=23.8° C.).

A solution of 45 g of di-tert-butyl peroxide (DTBP) and 22.5 g of tert-butyl peroctoate (TBPO) in 67.5 g of 2-butoxyethanol is also prepared.

These two preparations are then introduced simultaneously into the reactor, over a period of 2 hours at 135° C.

However, the synthesis of this copolymer is impossible due to the formation of a white solid in the reaction medium during the first 15 minutes. This white solid is due to the homopolymerization of the acrylic acid present in a large amount in the composition of P2.

| | Copolymer P1 | Copolymer P2 | Organic resin |
|---|---|---|---|
| Monomers | wt % P1 | wt % P2 | % by weight after |
| | (relative to the total | (relative to the total | mixing P1/P2; |
| | weight of P1 | weight of P2 | 75/25 |
| | monomers) | monomers) | (relative to the total |
| | | | weight of |
| | | | monomers) |
| Styrene | 41.34 | 24 | 37.0 |
| Butyl acrylate | 18.93 | 24.8 | 20.4 |
| Methyl methacrylate | 26 | 22.4 | 25.1 |
| 2-Dimethylaminoethyl methacrylate | 10 | 10.0 | 10.0 |
| Lauryl methacrylate | 3.73 | 3.6 | 3.7 |
| Acrylic acid | 0 | 11.2 | 2.8 |
| Methoxy polyethylene glycol | 0 | 4 | 1.0 |
| monomethacrylate | | | |
| (SR550 from Sartomer) | | | |
| Acid value (mg KOH/g) | 0 | 87.2 | 21.8 |

The percentage of acrylic acid in the copolymer P2 is determined so as to obtain an overall acid value after mixing 75% of P1 and 25% of P2 of 21.8 mg KOH/g, necessary for emulsifying the polymer after the neutralization and phase inversion step.

It is therefore impossible to synthesize P1 and P2 separately in order to obtain, after simple physical mixing and without copolymerization, a polymer having the same characteristics as that described in the invention. This shows the advantage of copolymerizing P1 and P2, one after the other in the same reaction medium.

1. An organic resin comprising in its composition two copolymers P1 and P2 in weight proportions of P1/P2 ranging from 90/10 to 60/40, wherein said copolymer P1 bears at least one tertiary amine group and said copolymer P2 bears at least one carboxylic acid group.

2. The resin as claimed in claim 1, wherein said copolymers P1 and P2 each bear at least one tertiary amine group.

3. The resin as claimed in claim 1 wherein said at least one tertiary amine group is borne by at least one ethylenically unsaturated monomer a).

4. The resin as claimed in claim 1 wherein said copolymers P1 and/or P2 are acrylic vinyl and/or vinyl-acrylic copolymers, including styrene-acrylic copolymers.

5. The resin as claimed in claim 1 wherein said copolymers P1 and/or P2 comprise at least one ethylenically unsaturated monomer b).

6. The resin as claimed in claim 1 wherein said copolymer P2 comprises at least one ethylenically unsaturated monomer bearing at least one carboxylic acid group c).

7. The resin as claimed in claim 1 wherein said copolymer P2 comprises at least one alkoxylated or polyalkoxylated group.

8. The resin as claimed in claim 7, wherein said copolymer P2 comprises at least one ethylenically unsaturated monomer bearing at least one alkoxylated or polyalkoxylated group d).

9. The resin as claimed in claim 8, wherein said monomer d) is an alkoxy-polyalkylene glycol mono(meth)acrylate monomer chosen from methoxy polyethylene glycol mono(meth)acrylate and ethoxy polyethylene glycol mono(meth)acrylate.

10. The resin as claimed in claim 1 which is self-dispersible in water after neutralization, without addition of surfactant or dispersant.

11. The resin as claimed in claim 1 in the form of a solution in at least one organic diluent having a weight content of resin ranging from 70% to 98%.

12. The resin as claimed in claim 1 wherein said organic diluent is a polar organic diluent bearing at least two functions selected from hydroxyl, ether and ester functions.

13. An aqueous resin dispersion comprising at least one resin as claimed in claim 1 in water-dispersed form, said resin being partially or completely neutralized by a neutralizing agent.

14. The aqueous dispersion as claimed in claim 13 which is devoid of surfactant and dispersant.

15. The aqueous dispersion as claimed in claim 13 having a solids content ranging from 30% to 60%.

16. A process for preparing an aqueous resin dispersion as claimed in claim 13 comprising the following steps:
i—preparing said resin in solution in at least one organic diluent,
ii—partially or completely neutralizing the carboxylic acid groups of said resin, by adding an amine, without affecting the other groups of said resin,
iii—preparing an aqueous dispersion of said resin by adding water until phase inversion.

17. The process as claimed in claim 16, wherein said resin is an acrylic, vinyl or vinyl-acrylic resin, including styrene-acrylic resin, and in that step i—of preparing said resin is carried out by radical polymerization.

18. The process as claimed in claim 16 wherein step i—of preparing said resin comprises the preparation of said copolymers P1 and P2 in two successive steps i1—and i2—in the same reactor:
i1—preparing, in solution, a first copolymer P1, and
i2—preparing a second copolymer P2, in the same reactor already containing said first copolymer P1.

19. A two-component crosslinkable composition comprising in an organic solvent medium or in an aqueous medium, at least one resin as claimed in claim 1 and an epoxy resin as crosslinking agent.

20. The crosslinkable composition as claimed in claim 19, which is an aqueous two-component coating composition further comprising an epoxy resin in aqueous dispersion or diluted in water.

21. The crosslinkable composition as claimed in claim 19 which is a composition devoid of catalyst based on metal derivatives.

22. The crosslinkable composition as claimed in claim 19 which is a coating composition chosen from the group consisting of paint, varnish, ink, adhesive, and glue.

23. A substrate coated with a crosslinkable coating composition as claimed in claim 19, said substrate chosen from substrates made of metal, glass, wood, chipboard, plywood, plastic, metal, concrete, plaster, composite, and textile.

24. (canceled)

25. (canceled)

26. (canceled)

27. The resin as claimed in claim 3, wherein said at least one ethylenically unsaturated monomer a) is an aminoalkyl (meth)acrylate monomer wherein said linear or branched alkyl comprises from 1 to 12 carbon atoms.

28. The resin as claimed in claim 5, wherein said at least one ethylenically unsaturated monomer b) is chosen from an alkyl (meth)acrylate wherein said linear or branched alkyl comprises at least 4 carbon atoms, monomers having a cycloaliphatic structure with at least 6 carbon atoms, an ester of C18 to C36 fatty acids with a hydroxyalkyl (meth)acrylate, an ester of vinyl alcohol with at least one linear or branched acid comprising at least 6 carbon atoms, acrylonitrile, vinyl esters, and vinyl aromatic monomers comprising from 6 to 18 carbon atoms.

29. The resin as claimed in claim 6, wherein said at least one ethylenically unsaturated monomer bearing at least one carboxylic acid group c) is chosen from (meth)acrylic acid, itaconic acid, itaconic anhydride, maleic acid, maleic anhydride, fumaric acid, crotonic acid, crotonic anhydride, tetrahydrophthalic acid, tetrahydrophthalic anhydride, dicarboxylic acid hemiesters with a hydroxyalkyl (meth)acrylate wherein said linear or branched alkyl comprises from 2 to 4 carbon atoms and may optionally be alkoxylated, and dicarboxylic acid hemiesters with a monohydroxylated polyether-mono(meth)acrylate or a polyester-mono(meth)acrylate oligomer.
